(19) United States
(12) Patent Application Publication
(10) Pub. No.: US 2025/0341450 A1
(43) Pub. Date: Nov. 6, 2025

(54) Cold Gas Stream Method for CryoEM Sample Grid Vitrification

(71) Applicant: The Board of Trustees of The Leland Stanford Junior University, Stanford, CA (US)

(72) Inventors: Aina Cohen, Pacifica, CA (US); Makaia Papasergi-Scott, Menlo Park, CA (US)

(21) Appl. No.: 18/860,847

(22) PCT Filed: May 9, 2023
(86) PCT No.: PCT/US2023/021550

§ 371 Date: Oct. 28, 2024

Related U.S. Application Data
(60) Provisional application No. 63/341,884, filed on May 13, 2022.

(51) Int. Cl. G01N 1/42

(52) U.S. Cl. CPC G01N 1/42

(57) ABSTRACT

A method of freezing an electron microscope sample is provided. A sample is deposited on an electron microscope grid to provide an electron microscope sample-grid. The electron microscope sample-grid is exposed to a cold gas stream core of a composite gas flow. The composite gas flow includes (i) the cold gas stream core, and (ii) a dry warm gas stream shell surrounding the cold gas stream core. The cold gas stream core freezes the sample in a time duration of 100 ms or less, and the warm gas stream shell prevents condensation onto the sample. The sample and cryoEM grid does not move during the vitrification process, and rather than being submerged in cryogenic liquid during and after vitrification, the sample is instead surrounded by a cold-gas stream. Being in a cold-gas stream, the sample grid can be imaged by a high-resolution video microscope prior to, during and after vitrification.

### FIELD OF THE INVENTION

The invention relates to methods of freezing an electron microscope sample

### BACKGROUND OF THE INVENTION

The most used sample cryo-vitrification technique involves a plunge freezing process, where samples on cryoEM (Cryo-Electron Microscopy) grids are rapidly accelerated into a cryogen bath (typically liquid ethane or liquid nitrogen). Other methods spray a liquid cryogen (ethane) onto cryoEM grids for vitrification following blot-less sample deposition. There are several disadvantages to these processes. First, the force applied to the grid during rapid entry into the liquid cryogen bath can sometimes bend or distort grids, Second, it is difficult to image the grid just prior to vitrification and during plunge freezing because the sample is moving at high speed.

It is also difficult to visualize a grid as a liquid cryogen is applied (sprayed). Third, it is difficult to image a grid immediately following the vitrification process because it is emersed in a cryogenic liquid. Imaging during and after vitrification is useful in order to understand if vitrification was successful and to measure the thickness of the sample deposited onto the grid before taking the time (and often monetary expense) to view grids in an electron microscope. Mapping which areas on the grid are best for cryoEM imaging prior to use of the electron microscope also saves expensive cryoEM instrument time. Fourth, because the grid is rapidly translated into the cryogen, when attempting to conduct some types of time-resolved experiments, immediately prior to vitrification, it is difficult to apply ample light (for photo-triggered reactions) or a controlled amount of chemical reactants on to the sample. It is also difficult to control and quantify the timing between reaction initiation and freeze-trapping (vitrification). Fifth, other methods of sample deposition and vitrification print fine lines of liquid sample onto a grid, but result in limited imageable area of grid space that can be effectively used for cryoEM data collection, and are challenged by ice-thickness necessitating the use of ultra-specialized nanowire grids or force-ion-beam milling that requires extensive training and specialized equipment. Sixth, fully enclosed systems impede the use of photo-activation for time-resolved experiments or ancillary spectroscopic methods. The present invention addresses these disadvantages or problems.

### SUMMARY OF THE INVENTION

The present invention provides a method of freezing an electron microscope sample. A sample is deposited on an electron microscope grid to provide an electron microscope sample-grid. Examples of samples are protein, complex containing multiple proteins, membrane vesicles, liposomes, or cells, or other cellular components. The electron microscope sample-grid is exposed to a cold gas stream core of a composite gas flow. The cold gas stream is e.g. a stream of nitrogen or helium and has a temperature range of under 100 K. The composite gas flow includes (i) the cold gas stream core, and (ii) a dry warm gas stream shell surrounding the cold gas stream core. The cold gas stream core freezes the sample in a time duration of 100 ms or less, and the warm gas stream shell prevents condensation onto the sample.

The surrounding dry warm gas stream is e.g. a stream of nitrogen or helium gas and above the dew point to avoid condensation onto the sample.

The method can be varied by surrounding the sample-grid with a humid gas stream to maintain the sample deposited on the grid in a moist environment to prevent the sample from over-drying before vitrification. Surrounding the grid in a humid stream is optional. The humid stream is present before the sample is deposited on the grid and remains flowing after grid blotting (to avoid dehydration). The humid stream is then blocked just prior to application of the cold gas stream. This to avoids the moisture in the gas from condensing onto the grid. If a humid stream is used, blocking the humid stream and then setting a specific delay before unblocking the cryogenic gas stream, is an important step to make the system work.

The method can also be varied by blotting the sample-grid with absorbent material (e.g., filter paper) to remove excess sample and solution in order to produce a thin aqueous film of sample particles throughout the sample-grid holes. The drop turns into a film after blotting.

Unlike present approaches, the sample and cryoEM grid does not move during the vitrification process, and rather than being submerged in cryogenic liquid during and after vitrification, the sample is instead surrounded by a cold-gas stream. Being in a cold-gas stream, the sample grid can be imaged by a high-resolution video microscope prior to, during and after vitrification. To prevent detrimental dehydration of the sample prior to vitrification, the sample-grid may be bathed in a humidity stream, including before and after grid blotting to remove excess sample-liquid. Exposure to a cold-gas stream for vitrification (instead of a liquid cryogen) minimizes the forces applied to the grid preventing damage or distortion of the grid. By using the tools developed in association with this invention, such as the metal “cryo-tong” the sample-grid may be safety transferred into liquid nitrogen for traditional grid handling operations.

Further, many problems and limitations associated with traditional plunge-freezing during sample preparation to conduct time-resolved cryoEM are mitigated with this approach. As the sample is not submerged or exposed to a liquid cryogen, it is not moving, and it is not within a sealed enclosure, it is straightforward to expose the sample-grid to various methods of triggers for time-resolved measurements (such as light and chemical triggering) and to perform complimentary methods for spectroscopic analysis.

### BRIEF DESCRIPTION OF THE DRAWINGS

FIG. 1 shows, according to an exemplary embodiment of the invention, the first phase of the cryo-stream vitrification set-up. The cryoEM grid is held by a specialized tweezer-pin attached to a goniometer that is used to manipulate the grid and align with a cryo-nozzle. The cryo-stream from a cryo-nozzle is initially blocked by a diverter while the grid is placed into position.

FIG. 2 shows, according to an exemplary embodiment of the invention, the second phase of the cryo-stream vitrification process, in which the grid is kept in a humid gas stream while sample is applied.

FIG. 3 shows, according to an exemplary embodiment of the invention, the third phase of the process, in which the grid is blotted to wick away excess sample from the grid.

FIG. 4 shows, according to an exemplary embodiment of the invention, the blotted grid kept in the humid stream to prevent desiccation prior to vitrification, during this time the grid may be inspected for blotting quality, reactants could be added, or laser uncaging of compounds may proceed for desired intervals.

FIG. 5 shows, according to an exemplary embodiment of the invention, the vitrification of the sample. During vitrification the humidity stream is disabled, while the cryo-stream blockage is removed, allowing for rapid freezing of the cryo-grid and sample. The cryo-stream has two layers: an inner stream of cold gas (e.g., nitrogen), and a dry-warm outer stream.

FIGS. 6A-B show, according to an exemplary embodiment of the invention, (FIG. 6A) cryoEM grids held by a specially designed tweezer-pins, and (FIG. 6B) cryo-tongs designed to hold the tweezer-pin and attached grid for transfer post-vitrification.

FIG. 7 shows, according to an exemplary embodiment of the invention, three magnifications of a cryo-grid vitrified using the invention, the grid is held within a cryo-stream allowing for light imaging and ice quality assessment immediately following vitrification.

FIG. 8 shows, according to an exemplary embodiment of the invention, that keeping the grid in the cryo-stream post-vitrification allows for IR laser treatment resulting in timed de-vitrification of the sample. When the IR laser is then removed the sample is rapidly re-vitrified which can serve to remove any non-vitreous (or crystalline) ice initially formed on the sample-grid.

FIG. 9 shows, according to an exemplary embodiment of the invention, UV photo-uncaging of light-reactant caged compounds mixed with protein sample on the cryoEM grid. UV laser illumination of the grid prior-to, or post-freezing in conjunction with IR devitrification techniques, allows for precise tuning of reaction timing.

FIG. 10 shows, according to an exemplary embodiment of the invention, in one application of the cryo-stream system, the cryoEM grid with blotted sample is vitrified in the cryo-stream, then the caged-reactant is uncaged using UV-laser illumination while the grid is kept frozen in the cryo-stream, then select areas of the grid are de-vitrified by an IR laser and re-vitrified by removing the IR-light pulse after the desired reaction time, allowing for tight control of a time-resolved reaction.

FIG. 11 shows, according to an exemplary embodiment of the invention, that using the cryo-stream vitrification method with UV-laser and IR-light pulses, the same sample can be used to assess consecutive intermediate states.

FIGS. 12 shows, according to an exemplary embodiment of the invention, a 3D reconstruction determined from a cryoEM grid vitrified using the invention with the map quality of individual residues shown inset (bottom).

### DETAILED DESCRIPTION

The inventors' approach is a new method to prepare vitrified sample containing grids (sample-grids) useful for single particle Cryo-Electron Microscopy (CryoEM). The goal of single particle CryoEM experiments is to visualize the structure of macromolecules by obtaining 3D density maps through the measurement and analysis of a set of low-dose images of individual macromolecules obtained using a cryo-electron microscope. Samples used in the microscope include macromolecules trapped within a thin film of vitreous ice located within small holes of a special sample holder called a cryoEM grid. It is important that the macromolecule particles within these sample-grids are mono-dispersed and that crystalline ice is avoided. Additives such as cryo-protectants are avoided as these can compromise the image contrast required for successful imaging of individual macromolecules.

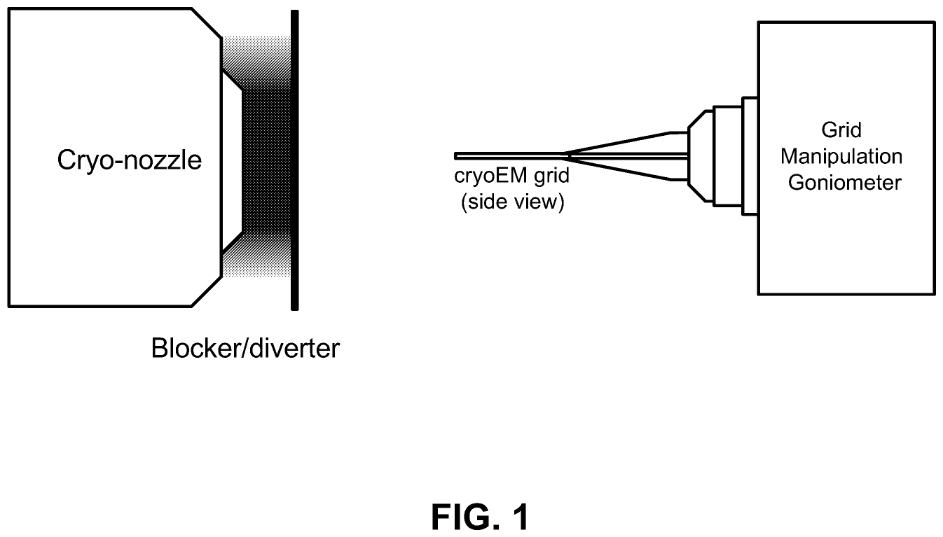

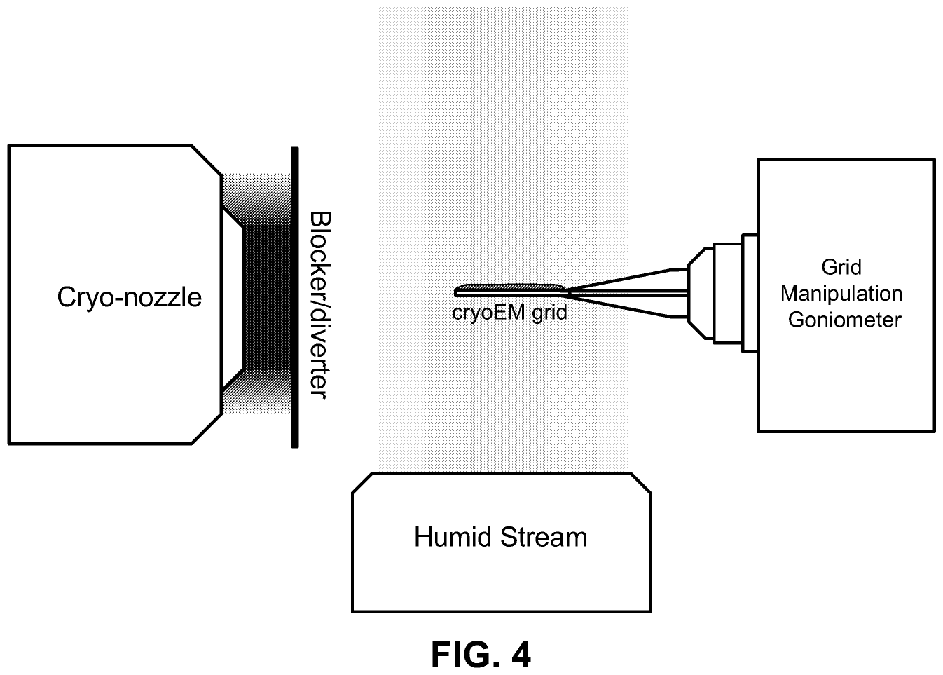

The new method for sample-grid preparation uses a temperature controlled cold gas stream (nitrogen or helium) delivered from a cryo-nozzle (FIGS. 1-5). The cold gas stream is surrounded by a dry warm stream of gas to prevent any condensation of liquid in the surrounding air from freezing in the cold gas stream (or onto the sample-grid).

Prior to vitrification, the gas stream is blocked from reaching the sample, such as with a heated metal blocking paddle (or manually with a plastic card. To vitrify the sample-grid, the cold gas stream is rapidly un-blocked, such as by rapidly translating the blocking paddle through solenoid control, (or manually by translating a plastic card).

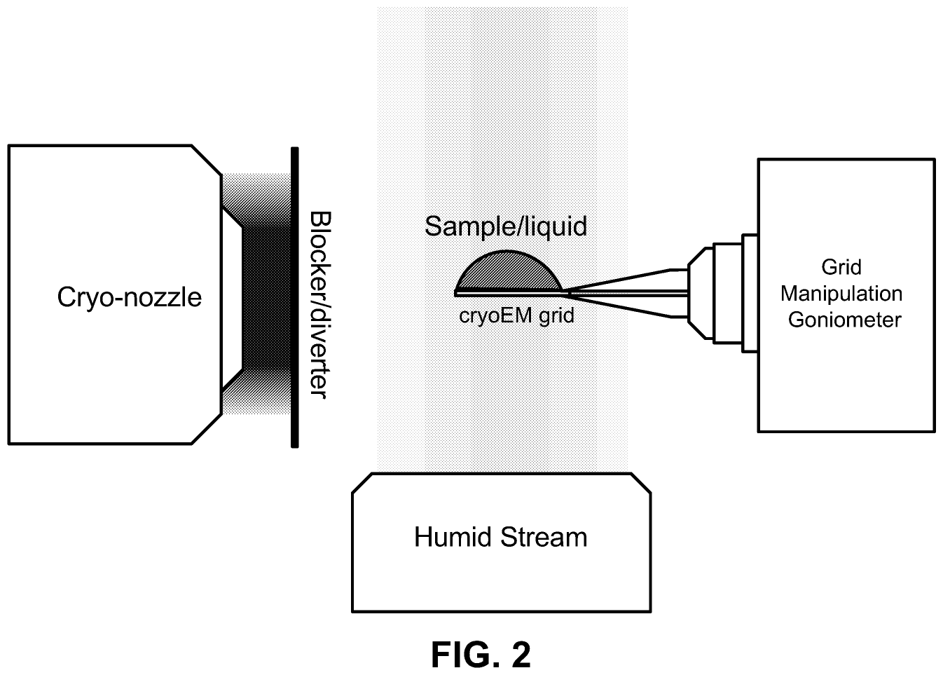

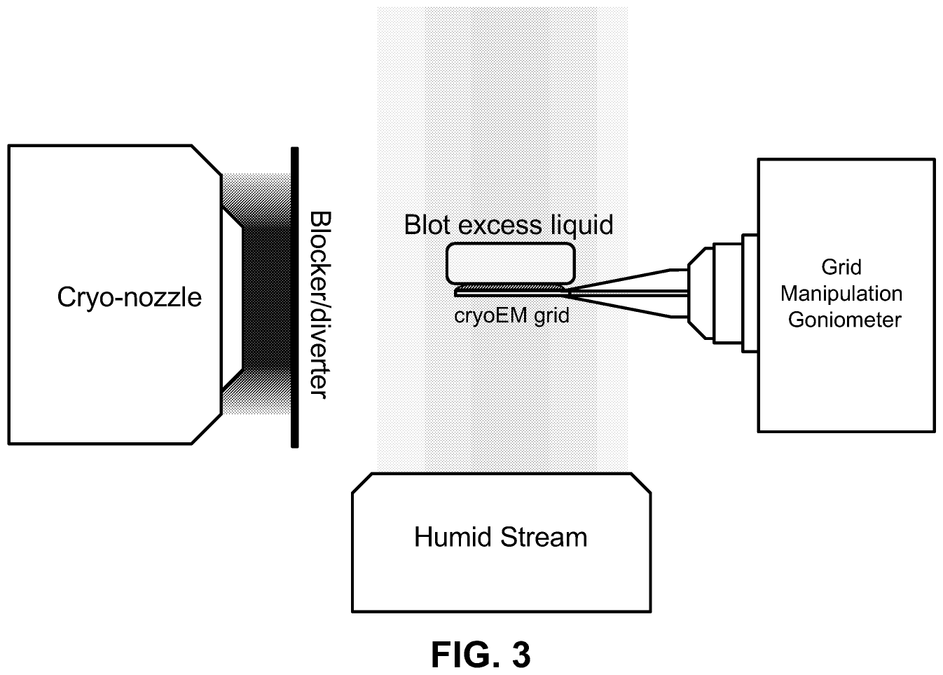

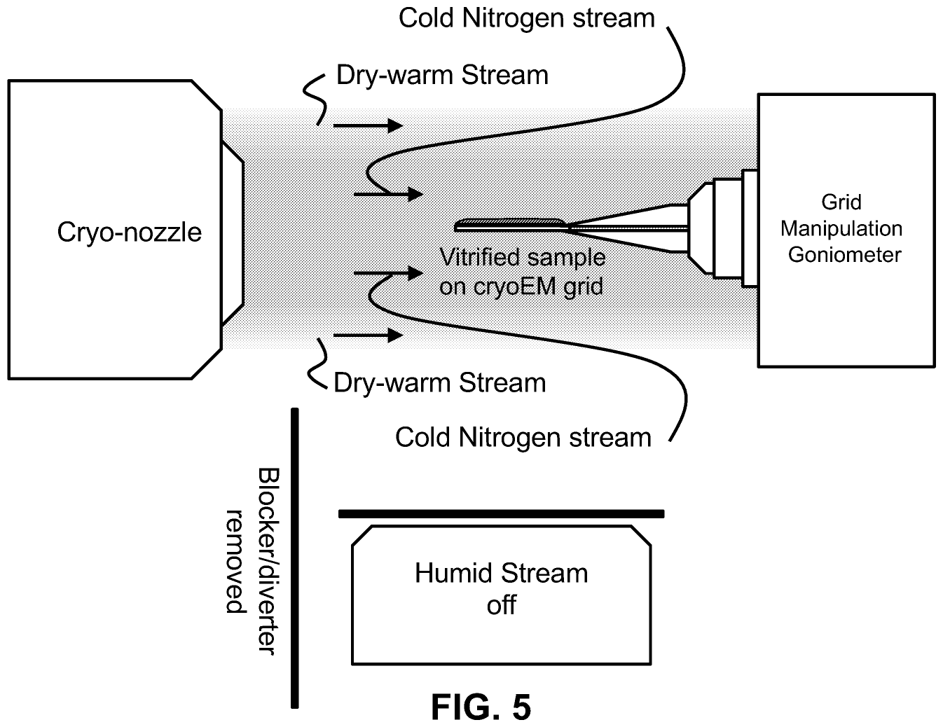

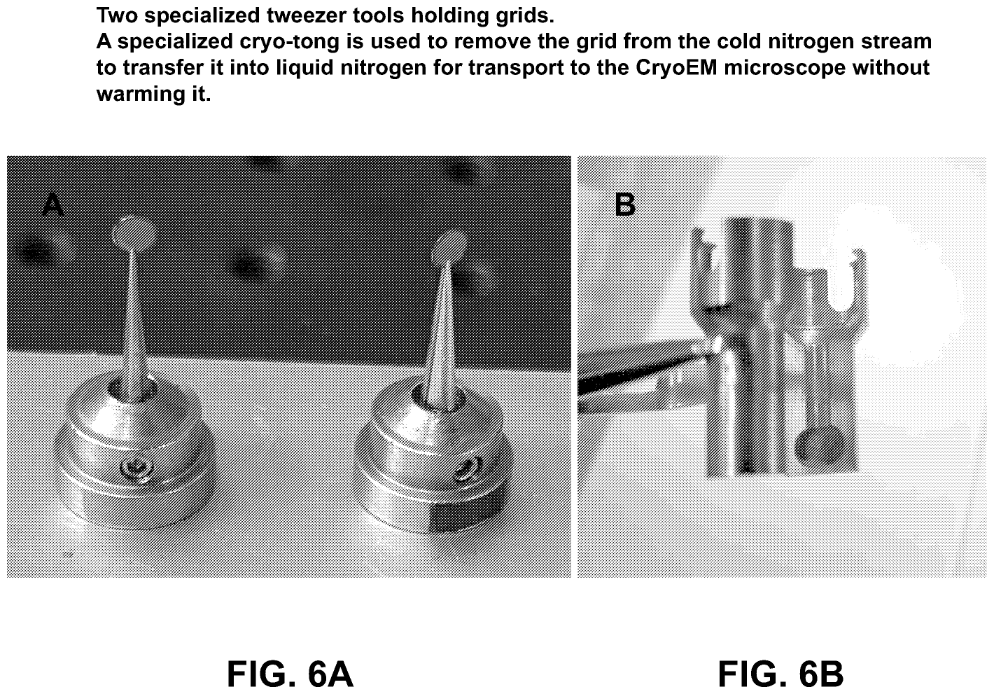

The steps of an exemplary process are as follows: The protein-sample solution is deposited onto a cryoEM grid which is held by a specialized tweezer device (FIG. 2, FIGS. 6A-B). The sample and cryoEM grid (sample-grid) may be surrounded by a humid gas stream during this process. The sample-grid may be blotted such as with a piece of absorbent material (e.g., filter paper) to remove excess sample (FIG. 3). The sample-grid may be imaged and exposed to a light or chemical trigger for time-resolved measurements. Immediately prior to vitrification, the humid stream is halted and the grid is exposed to a cold gas stream (such as nitrogen at 90 K, FIG. 5). The gas stream is directed over the entire cryoEM grid and tip of the tweezer to rapidly cool and vitrify the sample-grid.

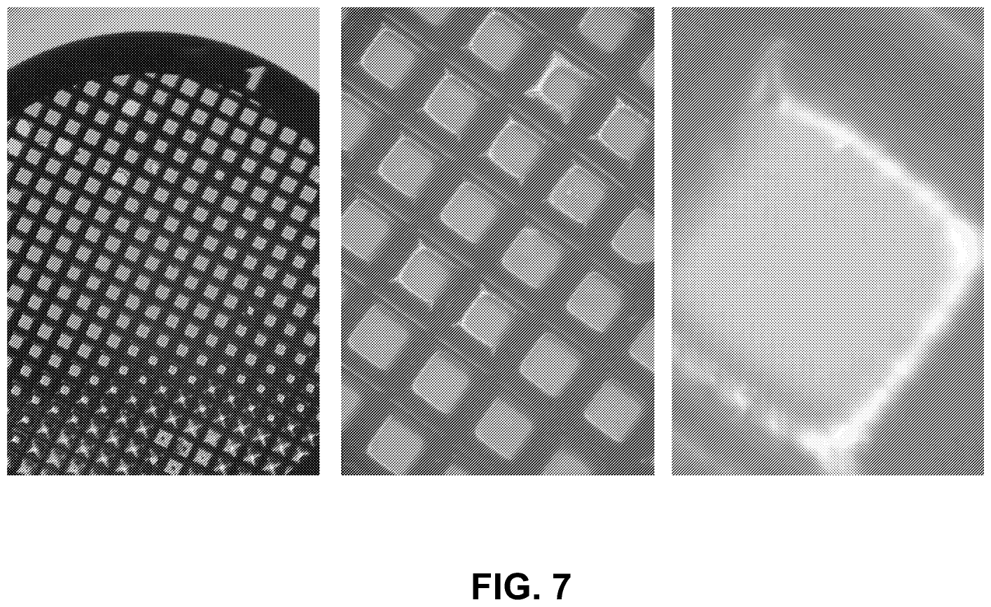

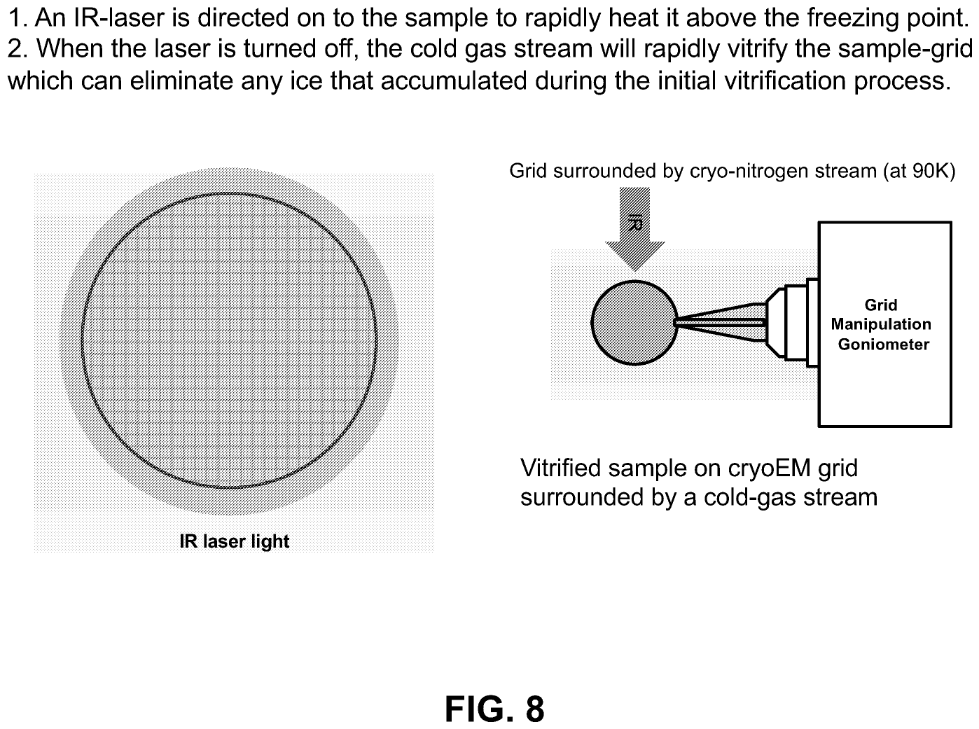

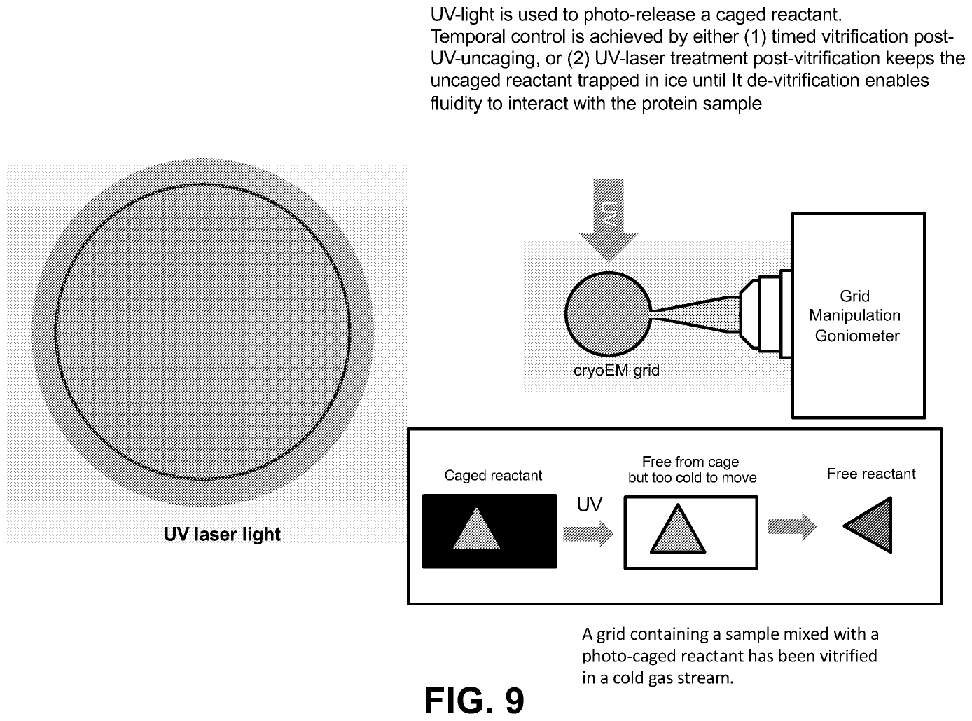

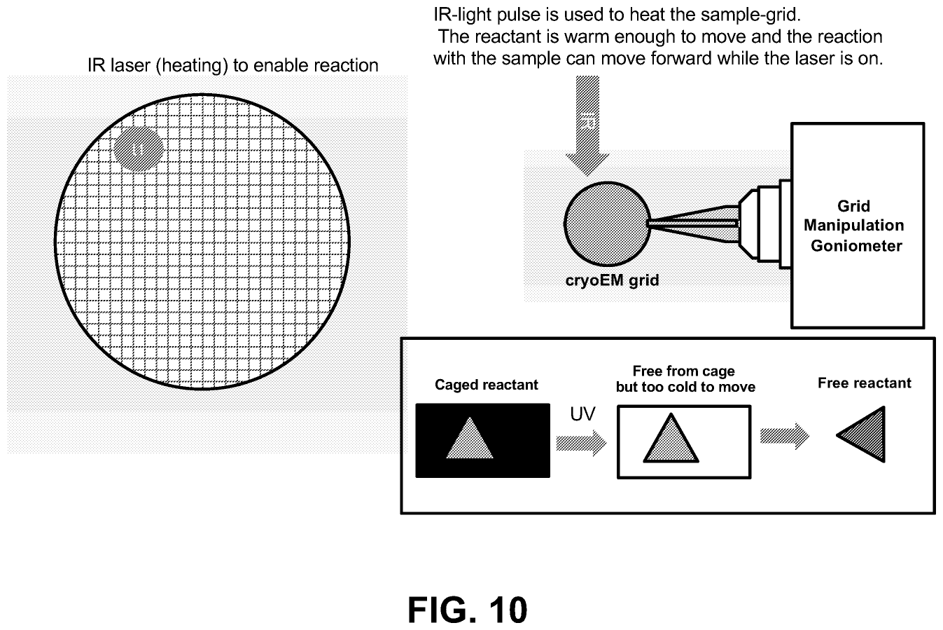

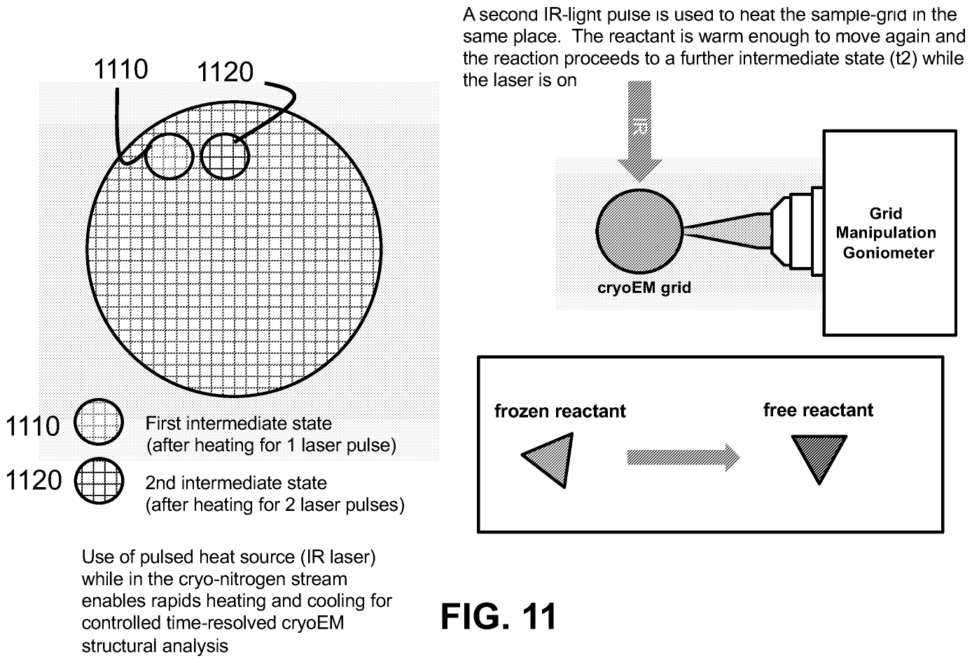

After vitrification the sample-grid can safely remain in the cold gas stream for imaging and other operations (FIG. 7). One operation that is an extension of this idea, is the use of an IR or temperature-jump laser to heat the sample-grid above the freezing point; as the grid is surrounded by the cold gas stream, it is rapidly vitrified when the temperature-jump laser is turned off (FIG. 8). This new “re-vitrification” method is useful to eliminate any ice previously formed on the sample-grid (FIG. 8) and for time-resolved measurements involving the photolysis of caged reactants (FIG. 9-11).

To safety remove the grid (and tweezer-device holding the grid) from the cold gas stream without warming up the grid, the inventors have developed a method that uses a specialized metal “cryo-tong” which has a metal chamber with an inside form factor that closely surrounds a grid; the metal is about 1 millimeter or closer to the grid surface (FIGS. 6A-B).

The metal of the cryo-tong is cooled prior to use such as by submerging the cryo-tong chamber in liquid nitrogen. The cryo-tong chamber is split so it may be opened to position the chamber halves near the grid while the sample-grid is inside the cold-gas stream (such as just above or below the gas stream). At this point, liquid nitrogen may remain in the bottom half of the cryo-tong chamber. The cryo-tong is quickly closed to enclose the sample grid inside the cold metal chamber. The sample-grid and tip of the tweezer device are held inside the chamber as the sample-grid is removed from the cold gas stream and submerged into liquid nitrogen where the cryo-tong may be opened to remove the sample-grid and the sample-grid may be released from the tweezer device. Standard CryoEM sample-grid handling procedures may be used to clip the sample-grid and store it for subsequent use in a cryo-electron microscope.

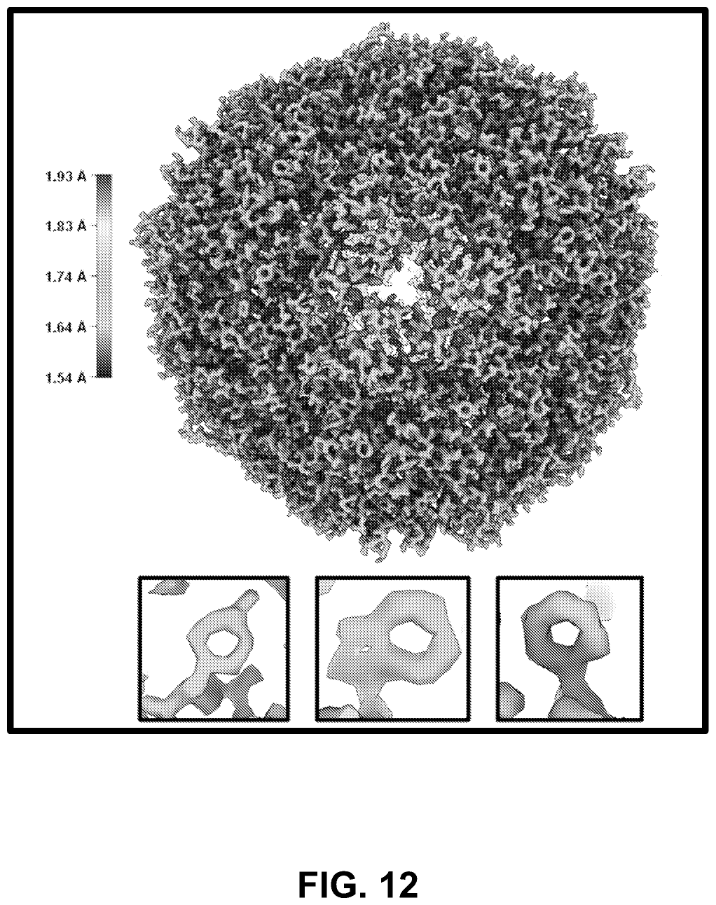

To develop the new “cold gas stream vitrification method for CryoEM sample-grid preparation”, the inventors had to overcome a number of difficulties, requiring optimization of the setup geometry, flow rates and timing, temperature settings, grid material and the development of specialized sample handing tools. For example, presently preferred embodiments have a gas-stream temperature below 95K and ideally under 90K, a sample to blocking paddle distance of 2 mm or shorter and make use of gold grids with holes of 0.6 μm or smaller. Following optimization, the invention proved to be effective to allow sufficient quality of cryoEM sample-grid, resulting in a high-resolution 3D reconstruction of the protein apoferritin (FIGS. 12).

One application of this invention is for the preparation of cryoEM sample containing grids (sample-grids) for CryoEM single particle imaging. The device can also be used to prepare sample-grids for other techniques that employ rapid vitrification of samples for electron microscopy applications. In particular, it mitigates some of the problems associated with available devices for sample-grid vitrification and it facilitates extra sample manipulation and probing steps to enable new types of time-resolved CryoEM analysis.

Significant advantages are provided. With the present approach, the sample and cryoEM grid does not move during the vitrification process. The sample grid is instead rapidly exposed to a cold-gas stream for vitrification. The sample grid can be imaged by a high-resolution video microscope prior to, during and after vitrification. To prevent detrimental dehydration of the sample prior to vitrification, the sample-grid may be bathed in a humidity stream, including before and after grid blotting to remove excess sample-liquid. Exposure to a cold-gas stream for vitrification (instead of a liquid cryogen) minimizes the forces applied to the grid preventing damage or distortion of the grid.

Together, many problems and limitations associated with traditional plunge-freezing, and in particular for sample preparation to conduct time-resolved cryoEM, are mitigated with this approach. As the sample is not submerged in a cryogen or exposed to a liquid cryogen, it is not moving, and it is not within a sealed enclosure, it is straightforward to expose the sample-grid to various methods of triggers for time-resolved measurements and to perform complimentary methods for spectroscopic analysis, as described below:
1) Because the sample grid is not moving and because it is only surrounded by gaseous nitrogen, the grids can be imaged using an optical microscope and by various spectroscopic methods such as Raman and UV-visible absorption and fluorescence techniques.
2) For time-resolved measurements, the sample grid may easily be exposed to lasers and photo-triggers at carefully controlled durations, before, during and after vitrification, enabling new methods for time-resolved cryoEM studies.
3) As the sample-grid does not move and may be maintained in a humid environment, prior to vitrification, it may also easily be exposed to reactant containing drops using drop-shooting devices and liquid injectors.
4) After initial vitrification, the sample may be exposed to light from temperature jump lasers for controlled heating and re-vitrification.

The list below identifies some commercial devices used for cryoEM vitrification and their specific weaknesses compared to the present approach. In addition, there is not a commercial device currently available that specializes in time-resolved cryoEM.
1) Thermo Fisher brand Vitrobot plunge freezers—see problems 1-4 listed in the background section.
2) Leica brand plunge freezers—see problems 1-4 listed in the background section.
3) Chameleon/Spotiton (STP Labtech)—sample droplet is printed onto grid surface, which limits the area of deposition and requires specialized nanotube grids to achieve adequate ice thickness without blotting.—see problems 1, 3-6 listed in the background section.
4) Cryosol VitroJet (Nanoscience Instruments)—all-in-one system, grids are pre-clipped and sample is printed onto the grid surface, the grid is then vitrified simultaneously on both faces of the grid by ethane jet streams.—see problems 3, 5-6 listed in the background section.

What is claimed is:

1. A method of freezing an electron microscope sample, comprising:
(a) depositing a sample on an electron microscope grid to provide an electron microscope sample-grid; and
(b) exposing the electron microscope sample-grid to a cold gas stream core of a composite gas flow;
wherein the composite gas flow includes (i) the cold gas stream core, and (ii) a dry warm gas stream shell surrounding the cold gas stream core,
wherein the cold gas stream core freezes the sample in a time duration of 100 ms or less, and
wherein the warm gas stream shell prevents condensation onto the sample.

2. The method as set forth in claim 1, wherein the sample is a protein, a complex containing multiple proteins, liposomes, cells, or cellular components.

3. The method as set forth in claim 1, wherein the cold gas stream is a stream of nitrogen or helium.

4. The method as set forth in claim 1, wherein the cold gas stream has a temperature range of under 100 K.

5. The method as set forth in claim 1, wherein the surrounding dry warm gas stream is a stream of nitrogen or helium gas.

6. The method as set forth in claim 1, wherein the surrounding dry warm gas is above the dew point to avoid condensation onto the sample.

7. The method as set forth in claim 1, further comprising surrounding the sample-grid with a humid gas stream to maintain the sample deposited on the grid in a moist environment to prevent the sample from over-drying before vitrification.
